(19) United States
(12) Patent Application Publication
(10) Pub. No.: US 2020/0220725 A1
(43) Pub. Date: Jul. 9, 2020

(54) SYSTEM AND METHOD FOR AUTHENTICATING A CALLER OF A TELEPHONIC CALL

(71) Applicant: HCL AMERICA, INC., SUNNYVALE, CA (US)

(72) Inventors: MICHAEL JAMES HUDSON, BOCA RATON, FL (US); JOHN WILLIAM BARRS, II, BOCA RATON, FL (US); PREDRAG MAKSIMOVIC, BOCA RATON, FL (US); VLADIMIR PERIC, BOCA RATON, FL (US)

(21) Appl. No.: 16/243,815

(22) Filed: Jan. 9, 2019

(51) Int. Cl. H04L 9/32; H04L 9/06; H04L 9/30; H04L 9/14; H04W 12/04; H04M 3/42; H04W 12/06

(52) U.S. Cl. CPC H04L 9/321; H04L 9/0637; H04L 9/30; H04L 9/14; H04M 2203/6027; H04W 12/04031; H04M 3/42059; H04W 12/06; H04L 2209/38; H04L 9/3242

(57) ABSTRACT

Disclosed is a system for authenticating a caller. The system assigns a public key and a private key to each Caller Identifications (CLID), of a plurality of CLIDs pertaining to a plurality of mobile telephony numbers. The system stores a plurality of CLIDs and a plurality of public keys, associated to the plurality of CLIDs, over a blockchain formed by the plurality of telephony service providers. The system sends a Multi Data Message Format (MDMF) message to a telephony service provider of a callee. The system analyzes the MDMF message to determine whether the CLID is present over the blockchain. The system enables the telephony service provider of the callee to retrieve a public key, of the plurality of public keys, corresponding to the CLID from the blockchain, when the CLID is present on the blockchain. The system authenticates the caller upon verifying the signature by using the public key.

### CROSS REFERENCE TO RELATED APPLICATIONS

This patent application does not claim priority from any application.

### TECHNICAL FIELD

The present subject matter described herein, in general, relates to a method and system for authenticating a caller of a telephonic call.

### BACKGROUND

Telephone calls are prone to the Caller Identification (CLID) spoofing problem. CLID comprises Calling Number (CND) and optionally Calling Name (CNAM). The manifestation of the problem is that a callee receiving a call sees on his/her User Equipment (UE) CLID information which does not belong to the actual person or entity making the call.

The two known CLID message format protocols are Single Data Message Format (SDMF) which allows for including only the CND, and Multi Data Message Format (MDMF) which allows for including both CND and CNAM. The formats for the CND (i.e. calling number) and the CNAM (i.e. calling name) are defined in Bellcore Documents TR-NWT-00031 and TR-NWT-001188 respectively. The MDMF specification leaves open the possibility for extending the MDMF format with additional parameters in the future.

More specifically, U.S. Pat. No. 6,324,271B1 covers a technology for certifying the caller by means of CLID protocols and provides examples for 1) modifying MDMF to include cryptographically signed data and 2) indicating certified caller by including special characters in CNAM value presented to the callee. However, U.S. Pat. No. 6,324,271B1 does not address sharing of public keys with non-trusted participating carriers which terminate the call. The control over data signing and signature verification is done by the telephony service provider of the caller who is assumed to be trusted by all other telephony service providers.

Spoofing CLID is possible due to the underlying CLID protocols which by design leave open the option for the caller to provide arbitrary CLID information when they place the call. Spoofing is an effective way to lead the called party to assume that the call is coming from a trusted or otherwise familiar source. For example, the area code in the CND is made to match the area code of the called party, leading the callee to believe that the call is originating from a nearby location, thus prompting the callee to answer the call. Answering the call may then expose them to spam, fraud or other threat attempts.

CLID spoofing may easily be achieved today by using open source software[s] that allows the caller to place calls on Public Switched Telephone Network (PSTN) and voice over Internet Protocol services where the calls include fabricated CLID information. In an even simpler form, it may be possible to use one of the existing public web-based services that allows the caller to create an account with a fake CLID and use the same service to place Voice over IP (VoIP) calls with the fake CLID.

For example, the bytes marked with (*) are CLID values that may be spoofed easily by the caller with malicious intentions.

| Field byte offset | |
|---|---|
| (Hexadecimal) | Field description |
| 80 | Message type word, 80 indicates MDMF |
| 20 | Length of data, 32 bytes in date, time, name and |
| | number |
| 01 | data type, 1 = date & time |
| 08 | length of date and time, 8 bytes |
| 30, 33 | 03, March |
| 32, 34 | 24, 24th day |
| 30, 39 | 09, hour |
| 30, 32 | 02, minutes (9:02am) |
| 07 | data type, 7 = name |
| 08 | length of name, 8 bytes |
| 4A* | ‘J’ |
| 4F* | ‘O’ |
| 48* | ‘H’ |
| 4E* | ‘N’ |
| 20* | ‘ ’ (space) |
| 44* | ‘D’ |
| 4F* | ‘O’ |
| 45* | ‘E’ |
| 02 | data type, 2 = phone number |
| 0A | length of phone number, 10 bytes |
| 38* | 8 |
| 30* | 0 |
| 30* | 0 |
| 35* | 5 |
| 35* | 5 |
| 35* | 5 |
| 31* | 1 |
| 32* | 2 |
| 31* | 1 |
| 32* | 2 |
| 7D | Checksum |

### SUMMARY

Before the present systems and methods are described, it is to be understood that this application is not limited to the particular systems and methodologies described as there can be multiple possible embodiments which are not expressly illustrated in the present disclosure. It is also to be understood that the terminology used in the description is for the purpose of describing the particular versions or embodiments only and is not intended to limit the scope of the present application. This summary is provided to introduce concepts related to systems and methods for authenticating a caller of a telephonic call and the concepts are further described below in the detailed description. This summary is not intended to identify essential features of the claimed subject matter nor is it intended for use in limiting the scope of the claimed subject matter.

In one implementation, a system for authenticating a caller of a telephonic call is disclosed. The system may comprise a processor and a memory coupled to the processor. The processor may execute a plurality of modules present in the memory. The plurality of modules may comprise a key assigning module, a caller's telephony service provider module, a callee's telephony service provider module, and an authentication module. The key assigning module may assign a public key and a private key to each Caller Identifications (CLID), of a plurality of CLIDs pertaining to a plurality of mobile telephony numbers. In one aspect, the public key and the private key may be assigned upon registration of a mobile telephony number with a telephony service provider of a plurality of telephony service providers. The key assigning module may further store the plurality of CLIDs and a plurality of public keys, associated to the plurality of CLIDs, over a blockchain, a shared, replicated, permissioned ledger with consensus, provenance, immutability, and finality, formed by the plurality of telephony service providers. The caller's telephony service provider module may send a Multi Data Message Format (MDMF) message to a telephony service provider of a callee over a telephony network. The MDMF message may be constructed by including a CLID, corresponding to a mobile telephony number belonging to the caller, and a Caller Signature (CSIG) indicating a signature used to encrypt a hash value, of the MDMF message, by using a private key assigned to the CLID belonging to the mobile telephony number. The callee's telephony service provider module may analyze the MDMF message to determine whether the CLID is present over the blockchain. The callee's telephony service provider module may enable the telephony service provider of the callee to retrieve a public key, of the plurality of public keys, corresponding to the CLID from the blockchain, when the CLID is present on the blockchain. The authentication module may authenticate the caller upon verifying the signature, used to encrypt the hash value, by using the public key retrieved for the CLID from the blockchain.

In another implementation, a method for authenticating a caller of a telephonic call is disclosed. In order to authenticate the caller, initially, a public key and a private key may be assigned to each Caller Identification (CLID), of a plurality of CLIDs pertaining to a plurality of mobile telephony numbers. In one aspect, the public key and the private key may be assigned upon registration of a mobile telephony number with a telephony service provider of a plurality of telephony service providers. Upon assignment of the public key and the private key, the plurality of CLIDs and a plurality of public keys, associated to the plurality of CLIDs, may be stored over a blockchain, a shared, replicated, permissioned ledger with consensus, provenance, immutability, and finality, formed by the plurality of telephony service providers. Subsequent to the storing of the plurality of public keys, a Multi Data Message Format (MDMF) message may be sent, by a telephony service provider of a caller, to a telephony service provider of a callee over a telephony network. In one aspect, the MDMF message may be constructed by including a CLID, corresponding to a mobile telephony number belonging to the caller, and a Caller Signature (CSIG) indicating a signature used to encrypt a hash value, of the MDMF message, by using a private key assigned to the CLID belonging to the mobile telephony number. Post sending the MDMF message, the MDMF message may be analyzed, by the telephony service provider of the callee, to determine whether the CLID is present over the blockchain. Further a public key, of the plurality of public keys, corresponding to the CLID may be retrieved from the blockchain, when the CLID is present on the blockchain. Once the public key is identified, the caller may be authenticated upon verifying the signature, used to encrypt the hash value, by using the public key retrieved for the CLID from the blockchain. In one aspect, the aforementioned method for authenticating the caller may be performed by a processor using programmed instructions stored in a memory of a system.

In one implementation, a non-transitory computer readable medium embodying a program executable in a computing device for authenticating a caller of a telephonic call is disclosed. The program may comprise a program code for assigning a public key and a private key to each Caller Identifications (CLID), of a plurality of CLIDs pertaining to a plurality of mobile telephony numbers, wherein the public key and the private key are assigned upon registration of a mobile telephony number with a telephony service provider of a plurality of telephony service providers. The program may further comprise a program code for storing the plurality of CLIDs and a plurality of public keys, associated to the plurality of CLIDs, over a blockchain, a shared, replicated, permissioned ledger with consensus, provenance, immutability, and finality, formed by the plurality of telephony service providers. The program may further comprise a program code for sending, by a telephony service provider of a caller, a Multi Data Message Format (MDMF) message to a telephony service provider of a callee over a telephony network, wherein the MDMF message is constructed by including a CLID, corresponding to a mobile telephony number belonging to the caller, and a Caller Signature (CSIG) indicating a signature used to encrypt a hash value, of the MDMF message, by using a private key assigned to the CLID belonging to the mobile telephony number. The program may further comprise a program code for analyzing, by the telephony service provider of the callee, the MDMF message to determine whether the CLID is present over the blockchain. The program may further comprise a program code for retrieving, by the telephony service provider of the callee, a public key, of the plurality of public keys, corresponding to the CLID from the blockchain, when the CLID is present on the blockchain. The program may further comprise a program code for authenticating the caller upon verifying the signature, used to encrypt the hash value, by using the public key retrieved for the CLID from the blockchain.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for authenticating a caller of a telephonic call, in accordance with an embodiment of the present subject matter.

FIG. 2 illustrates the system, in accordance with an embodiment of the present subject matter.

FIG. 3 illustrates the interconnection of different stakeholders of the system, in accordance with an embodiment of the present subject matter.

FIG. 4 illustrates a method for authenticating the caller, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The proposed invention facilitates to authenticate a caller of a telephonic call is disclosed. The proposed invention expands on various known art and uses a Multi Data Message Format (MDMF) format to store and deliver Caller Identification (CLID). The proposed invention further extends on various known art with the inclusion of an additional parameter holding a signed value verifiable with a public key associated with the CLID record stored on a distributed ledger, also referred to as a blockchain, to avoid CLID spoofing. In other words, the proposed invention facilitates to prevent CLID spoofing by introducing an additional verification layer relying on a registry of known callers shared between participating telephone service providers using the blockchain.

It may be noted that the distributed ledger is formed by participating telephony service providers. Examples of the participating telephony service providers may include, but not limited to, AT&T™, Sprint™, T-Mobile™, Verizon™, and Airtel™. It may be noted that users of the participating telephony service provider may choose to store their identity over the distributed ledger. As and when, a user wishes to be registered with a participating telephony service provider, a pair of Public-Private key may be assigned to each Caller Identification (CLID), of a plurality of CLIDs pertaining to a plurality of mobile telephony numbers, during the registration process. The identity of a caller may be stored in the form of the CLID and a Public key associated to the CLID. This may be done as part of onboarding or profile management and it results in a private key, of the pair of Public-Private key, being assigned to the CLID. It may be noted that the private key may be maintained by either the participating telephony service provider, or some third party custodian or subscribers themselves. If the subscribers themselves are maintaining the private key, the private key may be stored in a User Equipment, belonging to the caller, or may be provided to the subscribers for entering the private key in the software or the User equipment used to place the calls.

Upon registration and assignment of the pair of Public-Private key, if the caller makes the telephonic call to a callee, a MDMF message is constructed by including a CLID, corresponding to a mobile telephony number belonging to the caller, and a Caller Signature (CSIG). In one aspect, the CSIG indicates a signature used to encrypt a hash value, of the MDMF message, by using a private key assigned to the CLID belonging to the mobile telephony number. The MDMF message, including the CLID and the CSIG, may then be transmitted by a telephony service provider of the caller to a telephony service provider of the callee.

When the telephony service provider of the callee receives the MDMF message, the blockchain record is looked up for the CLID to determine whether the CLID is present over the blockchain. If the CLID is present on the blockchain, a public key, corresponding to the CLID, is retrieved from the blockchain and thereby verifies the signature, used to encrypt the hash value of the MDMF message, by using the public key. In other words, the public key is retrieved to verify the Initial_Validator_Signature by standard cryptographic means. Thus, in this manner, the caller of the telephonic call may be authenticated.

While aspects of described system and method for authenticating the caller may be implemented in any number of different computing systems, environments, and/or configurations, the embodiments are described in the context of the following exemplary system.

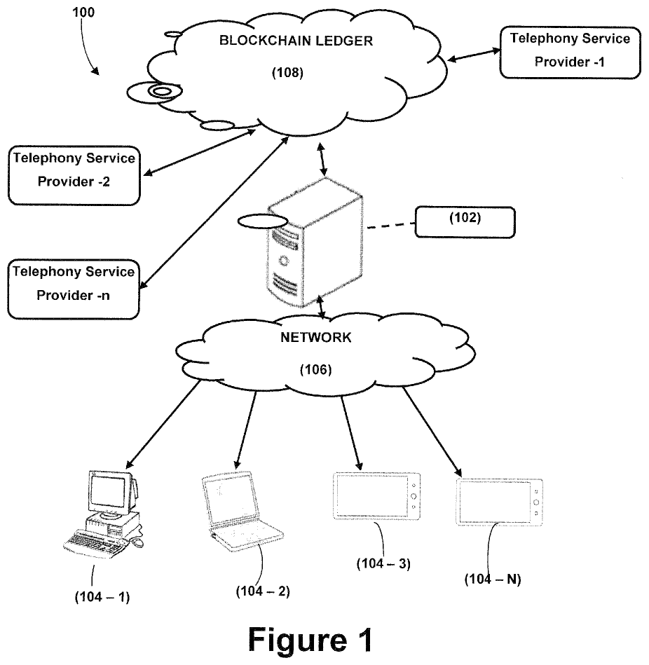

Referring now to FIG. 1, a network implementation 100 of a system 102 for authenticating a caller of a telephonic call is disclosed. In order to authenticate the caller, initially, the system 102 assigns a public key and a private key to each Caller Identifications (CLID), of a plurality of CLIDs pertaining to a plurality of mobile telephony numbers. In one aspect, the public key and the private key may be assigned upon registration of a mobile telephony number with a telephony service provider of a plurality of telephony service providers i.e. telephony service provider 1, telephony service provider 2, . . . , telephony service provider N. The system 102 further stores the plurality of CLIDs and a plurality of public keys, associated to the plurality of CLIDs, over a blockchain 108 formed by the plurality of telephony service providers. The system 102 enables a telephony service provider of a caller to send a Multi Data Message Format (MDMF) message to a telephony service provider of a callee over a telephony network. The MDMF message may be constructed by including a CLID, corresponding to a mobile telephony number belonging to the caller, and a Caller Signature (CSIG) indicating a signature used to encrypt a hash value, of the MDMF message, by using a private key assigned to the CLID belonging to the mobile telephony number. The system 102 further analyzes the MDMF message to determine whether the CLID is present over the blockchain 108. The system 102 enables the telephony service provider of the callee to retrieve a public key, of the plurality of public keys, corresponding to the CLID from the blockchain 108, when the CLID is present on the blockchain 108. The system 102 further authenticates the caller upon verifying the signature, used to sign the hash value, by using the public key retrieved for the CLID from the blockchain 108.

It may be understood that the system 102 may be implemented in a variety of computing systems, such as a laptop computer, a desktop computer, a notebook, a workstation, a mainframe computer, a server, a network server, a cloud-based computing environment. It will be understood that the system 102 may be communicatively coupled with the plurality of telephony service providers i.e. telephony service provider 1, telephony service provider 2, . . . , telephony service provider N. Examples of the plurality of telephony service providers may include, but not limited to, AT&T™, Sprint™, T-Mobile™, Verizon™, and Airtel™. Further the system 102 may be accessed by multiple users through one or more client machines 104-1, 104-2 . . . 104-N, collectively referred to as user 104 or stakeholders, hereinafter, or applications residing on the client machine 104. In one implementation, the system 102 may comprise the cloud-based computing environment in which a user may operate individual computing systems configured to execute remotely located applications. Examples of the client machines 104 may include, but are not limited to, a portable computer, a personal digital assistant, a handheld device, and a workstation. The client machine 104 is communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Hypertext Transfer Protocol Secure (HTTPS), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

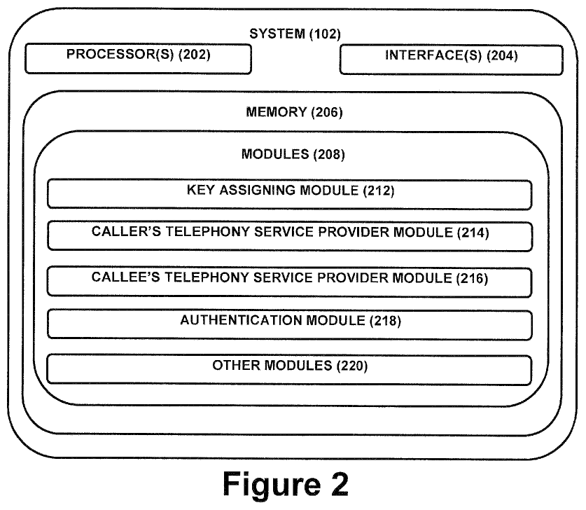

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208.

The modules 208 include routines, programs, objects, components, data structures, etc., which perform particular tasks or implement particular abstract data types. In one implementation, the modules 208 may include a key assigning module 212, a caller's telephony service provider module 214, a callee's telephony service provider module 216, an authentication module 218, and other modules 220. The other modules 220 may include programs or coded instructions that supplement applications and functions of the system 102. The modules 208 described herein may be implemented as software modules that may be executed in the cloud-based computing environment of the system 102.

As there are various challenges observed in the existing art, the challenges necessitate the need to build the system 102 for authenticating a caller of a telephonic call. In order to authenticate the caller, at first, a user may use the client machine 104 to access the system 102 via the I/O interface 204. The user may register them using the I/O interface 204 to use the system 102. In one aspect, the user may access the I/O interface 204 of the system 102. The system 102 may employ the key assigning module 212, the caller's telephony service provider module 214, the callee's telephony service provider module 216, and the authentication module 218. The detail functioning of the modules is described below.

The key assigning module 212 assigns a public key and a private key to each Caller Identifications (CLID) of a plurality of CLIDs pertaining to a plurality of mobile telephony numbers. It may be understood that each CLID may comprise a Calling Number (CND) and optionally a Calling Name (CNAM). In one aspect, the public key and the private key are assigned upon registration of a mobile telephony number with a telephony service provider of a plurality of telephony service providers. Examples of the participating telephony service providers may include, but not limited to, AT&T™, Sprint™, T-Mobile™, Verizon™, and Airtel™. Subsequent to the assignment of the public key and the private key to each CLID, the key assigning module 212 stores the plurality of CLIDs and a plurality of public keys, associated to the plurality of CLIDs, over a blockchain 108. In one aspect, the blockchain 108 is formed by the plurality of telephony service providers which indicates that the participants in the blockchain 108 are all participating telephony service providers.

In order to elucidate the functioning of the key assigning module 212, consider an example where the key assigning module 212 assigns a public key and a private key to a set of CLIDs, associated to a set of mobile telephony numbers, registered with at least one telephony service provider. Since each CLID comprises a CND and optionally a CNAM, the key assigning module 212 assigns a public key ‘PU₁’ and a private key ‘PR₁’ to a CLID having CND as ‘+19024489571’ belonging to a caller i.e. ‘John Doe’ hereinafter referred to as CNAM. It may be noted that the telephony service provider of ‘John Doe’ is ‘AT&T™’. Similarly, the key assigning module 212 assigns a public key ‘PU₂’ and a private key ‘PR₂’ to a CLID having CND as ‘+91980930813’ belonging to a callee i.e. ‘Ian Harvey’. It may be noted that the telephony service provider of ‘Ian Harvey’ is ‘Verizon™’. Subsequently, the key assigning module 212 stores association of ‘PU₁’ with ‘+19024489571’ and ‘PU₂’ with ‘+91980930813’ over the blockchain 108.

After storing the association of each CLID with a Public key over the blockchain 108, the caller's telephony service provider module 214 sends a Multi Data Message Format (MDMF) message, using a MDMF protocol, to a telephony service provider of the callee over a telephony network. It may be noted that the MDMF is an open ended protocol that may technically be extended with one or more parameters. For example, the MDMF message is capable of storing the CLID and may be extended with an additional parameter holding a signed value verifiable with the public key associated with the CLID stored over the blockchain 108.

It may be noted that the caller's telephony service provider module 214 sends the MDMF message to the telephony service provider of the callee when the caller makes the telephonic call to the callee. It may be noted that the MDMF message is constructed including a CLID, corresponding to the mobile telephony number belonging to the caller, and a Caller Signature (CSIG). The CSIG indicates a signature used to encrypt a hash value of the MDMF message. It may be noted that the hash value indicates a value computed upon processing the MDMF message (including the CLID with CND and CNAM values) by using at least one known algorithm such as sha256. It may be noted that the hash value may be encrypted by using a private key assigned to the CLID belonging to the mobile telephony number of the caller.

After sending the MDMF message, the callee's telephony service provider module 216 enables the telephony service provider of the caller to analyze the MDMF message. The MDMF message may be analyzed to determine whether the CLID is present over the blockchain 108. The callee's telephony service provider module 216 may then enable the telephony service provider of the callee to look for the CLID, belonging to the caller, over the blockchain 108.

Referring to the same example as aforementioned, considering that ‘John Doe’ makes a telephonic call to ‘Ian Harvey’. As soon as ‘John Doe’ establishes the telephonic call, a MDMF message is sent to the telephony service provider (i.e. Verizon™) of ‘Ian Harvey’ by the telephony service provider (i.e. AT&T™) of ‘John Doe’. The MDMF message comprises CND i.e. ‘+19024489571’ and CNM as ‘John Doe’. The MDMF message further comprises a CSIG, i.e. a hash value H₁. When Verizon™ receives the MDMF message, Verizon™ analyzes the MDMF message and look for the presence of the CLID (including CND and CNAM) of the callee (i.e. ‘+19024489571’ and ‘John Doe’ respectively) over the blockchain 108.

If it is determined that the CLID is present over the blockchain 108, the callee's telephony service provider module 216 retrieves a public key, of the plurality of public keys, associated to the CLID from the blockchain 108. Subsequently, the authentication module 218 authenticates the caller upon verifying the signature by decrypting the hash value of the MDMF message using the public key retrieved for the CLID from the blockchain 108. It may be noted that decrypting the hash value of the MDMF message resulting a generation of a decrypted hash value. It may be noted that the hash value and the decrypted hash value may be computed based on at least one known algorithm such as sha256. Subsequently the decrypted hash value is compared with the hash value. If the hash value is matched with the decrypted hash value, the CLID of the caller is considered as verified and thereby the caller is determined as authenticated.

In one aspect, if the CLID is present over the blockchain however the CSIG i.e. the hash value is absent in the MDMF message, the CLID of the caller is considered as unverified and thereby the caller is determined as unauthenticated. On the other hand, if the CLID is not found over the blockchain 108, or the decrypted hash value is not matched with the hash value, the CLID is considered as unverified and thereby the caller is determined as unauthenticated.

In one aspect, the authentication module 218 marks the CLID as verified when the caller is authenticated. In one example, if the caller is authenticated, the CLID is indicated with a use of a reserved symbol. In another example, the CLID is indicated with a specific color such as Green, when the CLID is considered as verified. Similarly, if the caller is unauthenticated, the CLID is indicated with a use of a reserved symbol which is different from the reserved symbol used to indicate the verified CLIDs. In another example, the CLID may be indicated with a specific color such as Red, when the CLID is considered as unverified. In such a scenario where the CLID is considered as unverified, the reserved symbol is omitted from the MDMF message and is only included when the CLID is considered as verified.

It may be noted that marking of the CLIDs with Green or Red color is illustrated as an embodiments of the aforementioned application. The authenticity of the caller may also be indicated with other indicators as well. For example, if the caller is authenticated, the CLID may be indicated with words such as “Mobile Telephony Number authenticated”. Similarly, if the caller is not authenticated, the CLID may be indicated with words such as “Mobile Telephony Number not authenticated”.

In order to elucidate the functioning of the callee's telephony service provider module 216 and the authentication module 218, continuing with the same example as aforementioned. If the presence of the CLID including the CND and CNAM (i.e. ‘+19024489571’ and ‘John Doe’ respectively) is present over the blockchain 108, the callee's telephony service provider module 216 retrieves ‘PU₁’, as the public key associated to ‘+19024489571’, from the blockchain 108. Thereafter the authentication module 218 decrypts the hash value H₁ using ‘PU₁’ to determine a decrypted hash value DH₁. Thereafter the authentication module 218 compares DH₁ with H₁.

If DH₁ is matched with H₁, then the authentication module 218 considers the CLID (‘+19024489571’) as verified and thereby the caller ‘John Doe’ is determined as an authenticated caller. In such a scenario, the CLID (‘+19024489571’) is marked with a specific reserved symbol indicating that ‘John Doe’ is an authenticated caller of the telephonic call. On the other hand, if the CLID (‘+19024489571’) is not found over the blockchain 108, or DH₁ is not matched with H₁, then the authentication module 218 considers the CLID (‘+19024489571’) as unverified and thereby the caller ‘John Doe’ is determined as an unauthenticated caller. In such a scenario, the CLID (‘+19024489571’) is marked with a specific reserved symbol indicating that ‘John Doe’ is an unauthenticated caller of the telephonic call. Thus, in this manner, the system 102 authenticates the caller of the telephonic call.

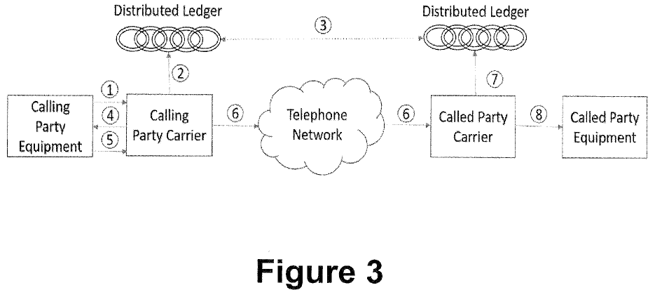

Referring now to FIG. 3, a method for authenticating a caller of a telephonic call is shown, in accordance with an embodiment of the present subject matter.

At step (1), subscribers of the participating telephony service providers may choose to store their CLIDs on the distributed ledger in the form of (CLID, public key). This may be done as part of subscribing to the service (onboarding), or subsequently as an add-on feature for the existing subscription (account management).

At step (2), the telephony service providers generate a private/public key pair corresponding to each CLID and stores the association, of the CLID and the public key, on the distributed ledger. It may be noted that the CLID comprises CND and optionally CNAM.

At step (3), the association of the CLID and the public key is shared with the telephony service providers associated with the distributed ledger through the consensus and synchronization process defined by the utilized distributed ledger technology.

At step (4), the private key may be maintained by the telephony service provider in the originating central office, by a third-party custodian in their own infrastructure, or by the subscriber themselves. In one aspect, the private key may be stored in the phone device or may be provided to the subscriber for them to enter in the software or a user equipment that the callers are using to place the calls.

At step (5), when the caller makes a call, a MDMF message is constructed including the CLID with CND and (optionally) CNAM values and a new signature MDMF parameter field (CSIG). It may be noted that the CSIG is the hash value calculated on the MDMF message and then encrypted by using the private key associated with the CLID.

At step (6), the call is routed to the telephony service provider of the callee.

At step (7), when the callee receives the call, the telephony service provider of the callee retrieves the CLID from the MDMF message and looks up the public key associated with the CLID from the distributed ledger. If the CLID is located in the distributed ledger, the public key is retrieved and used to decrypt the signature to retrieve a decrypted hash value to be compared with the hash value computed independently from the MDMF message. It may be noted that the hash value indicates a value computed upon processing the MDMF message (including the CLID with CND and CNAM values) by using at least one known algorithm such as sha256. If the decrypted hash value is matched with the hash value, the CLID is considered as verified. If the CLID is not found on the distributed ledger or the decrypted hash value is not matched with the hash value, the CLID is considered as unverified.

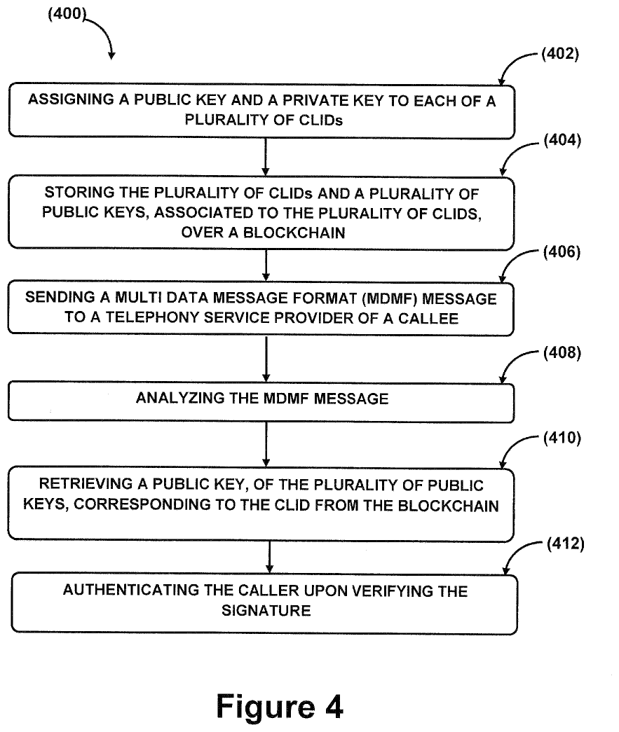

Referring now to FIG. 4, a method 400 for authenticating a caller of a telephonic call is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented as described in the system 102.

At block 402, a public key and a private key may be assigned to each Caller Identification (CLID) of a plurality of CLIDs pertaining to a plurality of mobile telephony numbers. In one aspect, the public key and the private key are assigned upon registration of a mobile telephony number with a telephony service provider of a plurality of telephony service providers. In one implementation, the public key and the private key may be assigned by the key assigning module 212.

At block 404, the plurality of CLIDs and a plurality of public keys, associated to the plurality of CLIDs, may be stored over a blockchain formed by the plurality of telephony service providers. In one implementation, the plurality of CLIDs and the plurality of public keys may be stored over the blockchain 108 by the key assigning module 212.

At block 406, a Multi Data Message Format (MDMF) message may be sent to a telephony service provider of a callee over a telephony network. In one aspect, the MDMF message may be constructed by including a CLID, corresponding to a mobile telephony number belonging to the caller, and a Caller Signature (CSIG) indicating a signature used to encrypt a hash value, of the MDMF message, by using a private key assigned to the CLID belonging to the mobile telephony number. In one implementation, the MDMF message may be sent by the caller's telephony service provider module 214.

At block 408, the MDMF message may be analyzed to determine whether the CLID is present over the blockchain. In one implementation, the MDMF message may be analyzed by the callee's telephony service provider module 216.

At block 410, retrieving a public key, of the plurality of public keys, corresponding to the CLID from the blockchain, when the CLID is present on the blockchain. In one implementation, the public key may be retrieved by the callee's telephony service provider module 216.

At block 412, the caller may be authenticated upon verifying the signature, used to encrypt the hash value, by using the public key retrieved for the CLID from the blockchain. In one implementation, the caller may be authenticated by the authentication module 218.

Exemplary embodiments discussed above may provide certain advantages. Though not required to practice aspects of the disclosure, these advantages may include those provided by the following features.

Some embodiments enable a system and a method to add an additional verification layer relying on a registry of known callers shared between participating telephony service providers using distributed ledger technology.

Although implementations for methods and systems for authenticating a caller of a telephonic call have been described in language specific to structural features and/or methods, it is to be understood that the appended claims are not necessarily limited to the specific features or methods described. Rather, the specific features and methods are disclosed as examples of implementations for authenticating the caller.

1. A computer implemented method for authenticating a caller of a telephonic call, the computer implemented method comprising:
assigning, by a processor, a public key and a private key to each Caller Identification (CLID) of a plurality of CLIDs pertaining to a plurality of mobile telephony numbers, wherein the public key and the private key are assigned upon registration of a mobile telephony number with a telephony service provider of a plurality of telephony service providers;
storing, by the processor, the plurality of CLIDs and a plurality of public keys, associated to the plurality of CLIDs, over a blockchain formed by the plurality of telephony service providers;
sending, by a telephony service provider of a caller, a Multi Data Message Format (MDMF) message to a telephony service provider of a callee over a telephony network, wherein the MDMF message is constructed by including the CLID corresponding to a mobile telephony number belonging to the caller, and a Caller Signature (CSIG) indicating a signature used to encrypt a hash value, of the MDMF message, by using the private key assigned to the CLID belonging to the mobile telephony number;
analyzing, by the telephony service provider of the callee, the MDMF message to determine whether the CLID is present over the blockchain;
retrieving, by the telephony service provider of the callee, the public key of the plurality of public keys corresponding to the CLID from the blockchain, when the CLID is present on the blockchain; and
authenticating, by the processor, the caller upon verifying the signature used to encrypt the hash value by using the public key retrieved for the CLID from the blockchain.

2. The method as claimed in claim 1, wherein each CLID comprises a Calling Number (CND) and a Calling Name (CNAM).

3. The method as claimed in claim 1, wherein the CSIG comprises
computing, by the processor, a hash value for the MDMF message; and
encrypting, by the processor, the hash value by using the private key associated to the CLID belonging to the mobile telephony number of the caller.

4. The method as claimed in claim 1, wherein the caller is authenticated by,
retrieving, by the processor, a decrypted hash value present in the CSIG, wherein the decrypted hash value is retrieved by decrypting the signature using the public key corresponding to the CLID;
comparing, by the processor, the decrypted hash value with the hash value; and
authenticating, by the processor, the caller when the decrypted hash value is matched with the hash value.

5. The method as claimed in claim 1, wherein the MDMF message is marked as verified when the caller is authenticated, and wherein the MDMF message is marked as unverified when the caller is not authenticated, and wherein the caller is not authenticated when the CLID is absent over the blockchain or the decrypted hash value is not matched with the hash value.

6. A system for authenticating a caller of a telephonic call, the system comprising:
a processor; and
a memory coupled to the processor, wherein the processor is capable of executing a plurality of modules stored in the memory, and wherein the plurality of modules comprising:
a key assigning module for
assigning a public key and a private key to each Caller Identifications (CLID), of a plurality of CLIDs pertaining to a plurality of mobile telephony numbers, wherein the public key and the private key are assigned upon registration of a mobile telephony number with a telephony service provider of a plurality of telephony service providers, and
storing the plurality of CLIDs and a plurality of public keys, associated to the plurality of CLIDs, over a blockchain formed by the plurality of telephony service providers;
a caller's telephony service provider module for sending a Multi Data Message Format (MDMF) message to a telephony service provider of a callee over a telephony network, wherein the MDMF message is constructed by including the CLID, corresponding to a mobile telephony number belonging to the caller, and a Caller Signature (CSIG) indicating a signature used to encrypt a hash value, of the MDMF message, by using the private key assigned to the CLID belonging to the mobile telephony number;
a callee's telephony service provider module for:
analyzing the MDMF message to determine whether the CLID is present over the blockchain, and
retrieving, by the telephony service provider of the callee, the public key of the plurality of public keys corresponding to the CLID from the blockchain, when the CLID is present on the blockchain; and
an authentication module for authenticating the caller upon verifying the signature used to encrypt the hash value by using the public key retrieved for the CLID from the blockchain.

7. The system as claimed in claim 6, wherein each CLID comprises a Calling Number (CND) and a Calling Name (CNAM).

8. The system as claimed in claim 6, wherein the authentication module authenticates the caller by,
retrieving a decrypted hash value present in the CSIG, wherein the decrypted hash value is retrieved by decrypting the signature using the public key corresponding to the CLID;
comparing the decrypted hash value with the hash value; and
authenticating the caller when the decrypted hash value is matched with the hash value.

9. The system as claimed in claim 6, wherein the MDMF message is marked as verified when the caller is authenticated, and wherein the MDMF message is marked as unverified when the caller is not authenticated, and wherein the caller is not authenticated when the CLID is absent over the blockchain or the decrypted hash value is not matched with the hash value.

10. A non-transitory computer readable medium embodying a program executable in a computing device for authenticating a caller of a telephonic call, the program comprising a program code:
a program code for assigning a public key and a private key to each Caller Identifications (CLID), of a plurality of CLIDs pertaining to a plurality of mobile telephony numbers, wherein the public key and the private key are assigned upon registration of a mobile telephony number with a telephony service provider of a plurality of telephony service providers;
a program code for storing the plurality of CLIDs and a plurality of public keys, associated to the plurality of CLIDs, over a blockchain formed by the plurality of telephony service providers;
a program code for sending, by a telephony service provider of a caller, a Multi Data Message Format (MDMF) message to a telephony service provider of a callee over a telephony network, wherein the MDMF message is constructed by including the CLID, corresponding to a mobile telephony number belonging to the caller, and a Caller Signature (CSIG) indicating a signature used to encrypt a hash value, of the MDMF message, by using the private key assigned to the CLID belonging to the mobile telephony number;
a program code for analyzing, by the telephony service provider of the callee, the MDMF message to determine whether the CLID is present over the blockchain;
a program code for retrieving, by the telephony service provider of the callee, the public key of the plurality of public keys corresponding to the CLID from the blockchain, when the CLID is present on the blockchain; and
a program code for authenticating the caller upon verifying the signature used to encrypt the hash value by using the public key retrieved for the CLID from the blockchain.
